(19) United States
(12) Patent Application Publication
(10) Pub. No.: US 2004/0126543 A1
(43) Pub. Date: Jul. 1, 2004

(54) Striped material and stripe-forming apparatus

(76) Inventors: David Charles Potts, Dunwoody, GA (US); Yen-Ling Lai, Houston, TX (US); Brian Eric Lin, Alpharetta, GA (US); Christopher Andrew Laslie, Cumming, GA (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/331,141

(22) Filed: Dec. 27, 2002

(51) Int. Cl. B32B 3/00

(52) U.S. Cl. 428/195.1

(57) ABSTRACT

A striped material and a stripe focusing plate for making striped material. The stripe focusing plate includes a number of grooves extending through the plate, each groove having a transverse width l. The stripe focusing plate also includes a number of triangular prisms, each adjacent a groove and having a slope between about 70 and about 85 degrees. Particles distributed onto the plate fall through the grooves onto a substrate positioned below the plate to form stripes on the substrate. Each of the stripes has a half-height width L, and a sharpness coefficient L/l of less than 1. The resulting striped material is particularly suitable for use in disposable absorbent articles.

### BACKGROUND OF THE INVENTION

This invention is directed to striped material, and a stripe focusing plate for forming stripes on a substrate. The striped material is particularly suitable for use in disposable absorbent products.

Stripes may be formed on a substrate for aesthetic reasons as well as for functional benefits. For example, particles from which the stripes are formed may provide absorbency, odor-control, fluid modification, or various other functions. Stripes may be preferable over a solid layer of such particles for a number of reasons, including cost-savings as well as for the sake of providing exposure to the underlying substrate. If the stripes are non-uniform, the material may have a sloppy look, or a dirty look if the powder has a color.

When stripes are formed of solid particles, as opposed to fluids, it is difficult to achieve sharply defined and uniform stripes on a substrate. By merely splitting a stream of particles into multiple streams, a number of stripes may be formed, but the resulting stripes may not be uniform and most likely lack definition. Furthermore, particles may have a tendency to stick to a stripe-forming device, consequently plugging up the device, thus resulting in an even greater lack of uniformity among the stripes in terms of appearance as well as inconsistency in the amount of particles in each stripe.

There is a need or desire for a striped material having well-defined, uniform stripes that enhance the functionality of the material. There is a further need or desire for a stripe-forming apparatus that can be used to apply well-defined, uniform stripes to a substrate.

### SUMMARY OF THE INVENTION

In response to the discussed difficulties and problems encountered in the prior art, a striped material having well-defined, uniform stripes that enhance the functionality of the material, and a stripe focusing plate that can be used to apply well-defined, uniform stripes to a substrate, have been discovered.

It has been discovered that relatively concentrated stripes of particles cause a localized change in the thickness of a material. This addition of mass, and possibly increased density, can be used with the activity of the particles to modify fluid movement. For example, the particles may be active in the sense that they may provide absorbency, odor-control, fluid modification, or various other functions in response to substances that contact the striped material, and the striped configuration of the particles on a substrate may be used to further control the movement of fluid that comes into contact with the striped material.

The stripe focusing plate of the invention includes a number of grooves extending through the plate, each groove having a transverse width l. The stripe focusing plate also includes a number of triangular prisms, each adjacent a groove and having a slope between about 45 and about 85 degrees. The plate and/or the prisms may include a polycarbonate material or any other suitable material. Particles distributed onto the plate fall through the grooves onto a substrate positioned below the plate to form stripes on the substrate. Each of the stripes has a half-height width L, and a sharpness coefficient L/l of less than 1. Thus, the stripes are relatively uniform and well-defined. The rate at which the material is deposited onto the plate and the slope of the prisms are factors that affect the amount of particles that adhere to the sides of the prisms.

The striped material includes the substrate with the particles arranged in stripes on the substrate, the stripes having a sharpness coefficient L/l of less than 1. The particles may include a gelling agent, superabsorbent, activated carbon, a pigment, or the like. The stripes are suitably parallel to one another. In another embodiment, the material may include two sets of parallel stripes, each set perpendicular to one another to form checks or dams that prevent the spread of fluid that comes in contact with the web.

The substrate may be an airlaid material or any other suitable material. In one embodiment, the striped material may include a second substrate overlaying the stripes such that the stripes are positioned between the two substrates. The second substrate may be an airlaid material as well.

The resulting striped material is particularly suitable for use in disposable absorbent articles, such as catamenial articles and disposable absorbent pants.

With the foregoing in mind, particular embodiments of the invention provide a striped material having well-defined, uniform stripes that enhance the functionality of the material, and a stripe focusing plate that can be used to apply well-defined, uniform stripes to a substrate.

### BRIEF DESCRIPTION OF THE DRAWINGS

FIG. 1 is a top view of a striped material of the invention.

FIG. 2 is an enlarged, partial cross-sectional view of the striped material, taken along line 2-2, in FIG. 1.

FIG. 3 is a side view of the stripe focusing plate of the invention.

FIG. 4 is a top view of the stripe focusing plate in FIG. 3.

FIG. 5 is an enlarged view of a prism on the stripe focusing plate shown in FIG. 3.

FIG. 6 is a perspective view of another embodiment of the striped material of the invention.

FIG. 7 is graph of data used to calculate the half-height width of stripes on samples in Example 2.

### DEFINITIONS

Within the context of this specification, each term or phrase below will include the following meaning or meanings.

“Airlaid” refers to a material produced by forming previously individualized fiber with or without other materials and bonding them together with adhesives, glues, and/or heat-activated binder fiber.

“Catamenial articles” refers to feminine hygiene products such as sanitary napkins, pads, and tampons.

“Disposable absorbent articles” include, without limitation, diapers, training pants, swimwear, absorbent underpants, adult incontinence products, feminine hygiene products, absorbent wipes, and the like, as well as protective garments, including medical garments and industrial protective garments.

“Machine direction” as applied to a substrate, refers to the direction on the substrate that was parallel to the direction of travel of the substrate as it left the extrusion or forming apparatus, or as it travels through a treatment process. If the substrate passed between nip rollers or chill rollers, for instance, the machine direction is the direction on the substrate that was parallel to the surface movement of the rollers when in contact with the substrate. “Cross direction” refers to the direction perpendicular to the machine direction. Dimensions measured in the cross direction are referred to as “width” dimensions, while dimensions measured in the machine direction are referred to as “length” dimensions.

“Nonwoven” or “nonwoven web” refers to materials and webs of material having a structure of individual fibers or filaments which are interlaid, but not in an identifiable manner as in a knitted fabric. The terms “fiber” and “filament” are used interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Superabsorbent” refers to a water-swellable, water-insoluble organic or inorganic material capable, under the most favorable conditions, of absorbing at least about 15 times its weight and, more desirably, at least about 30 times its weight in an aqueous solution containing 0.9 weight percent sodium chloride. The superabsorbent materials can be natural, synthetic and modified natural polymers and materials. In addition, the superabsorbent materials can be inorganic materials, such as silica gels, or organic compounds such as cross-linked polymers.

These terms may be defined with additional language in the remaining portions of the specification.

### DESCRIPTION OF PREFERRED EMBODIMENTS

The present invention is directed to striped materials and a stripe focusing plate for forming stripes on a substrate to create such striped materials. The striped materials are particularly suitable for use in disposable absorbent products. The stripes on these materials may be continuous along the machine direction of the web or discontinuous such that one or more areas of the web in the machine direction have stripes followed by one or more areas without stripes.

Referring to FIG. 1, there is shown a striped material 20 of the invention. The stripes 22 are formed of particles 24 deposited through a stripe focusing plate onto a substrate 26. The resulting stripes 22 are well-defined and uniform. Furthermore, the stripes 22 enhance the functionality of the material 20.

The particles 24 from which the stripes 22 are formed are suitably functional particles in the sense that the particles contribute added functionality to the material. For example, the particles 22 may include a gelling agent, superabsorbent, activated carbon, a pigment, or the like.

Gelling agent particles would be particularly suitable for providing stripes on catamenial articles. More specifically, gelling agents can be used to agglomerate red blood cells in a blood-containing fluid, such as menses, leaving a fluid that is easier to absorb and less strongly colored. Thus, the stripes of gelling agent could agglomerate the red blood cells while an absorbent substrate could absorb the fluid portion of the blood-containing fluid. Examples of commercially available gelling agents include CELQUAT (National Starch and Chemical Company) which is a polyquaternium cellulosic polymer, UCARE polymers which include aminated cellulose (Amercol division of Dow) and chitosan (Vanson).

Superabsorbent particles would be suitable for providing stripes in a number of disposable absorbent products. More particularly, the superabsorbent stripes could absorb large quantities of liquids, such as urine, while any run-off or liquid that is not immediately absorbed into the stripes could be absorbed by an absorbent substrate. Superabsorbent materials suitable for use in the present invention include polyacrylate materials obtained from Stockhausen under the designations FAVOR SXM 77 and FAVOR SXM 880, as well as polyacrylate materials obtained from Dow Chemical, USA, under the designation of DryTech 2035.

Activated carbon particles would be suitable for providing stripes on a number of disposable absorbent products, particularly products typically used to absorb malodorous substances. For example, the activated carbon stripes could be applied to a catamenial article or the crotch portion of a diaper or other incontinence product to absorb the odor of any insult issued to the surface while the underlying substrate could be an absorbent substrate that captures the insult itself. While activated carbon is an effective tool in odor-prevention, it is typically not used in disposable absorbent products because of consumers' hesitation to use black absorbent products. Most absorbent products are white, or light-colored, which allows a consumer to see whether the product is soiled. Black absorbent products are more difficult to discern soiled status. By having stripes of activated carbon on a white or other light-colored absorbent substrate, the stripes may serve to absorb odors while the underlying absorbent may absorb any liquids, and a consumer may still easily visually detect any soiling on the surface of the material.

Pigment particles may be used for aesthetic purposes, thereby adding stripes to a material simply to enhance the appearance of the material. Alternatively, pigment particles may be combined with other functional particles, such as a gelling agent or superabsorbent, to accentuate the presence of the functional stripes.

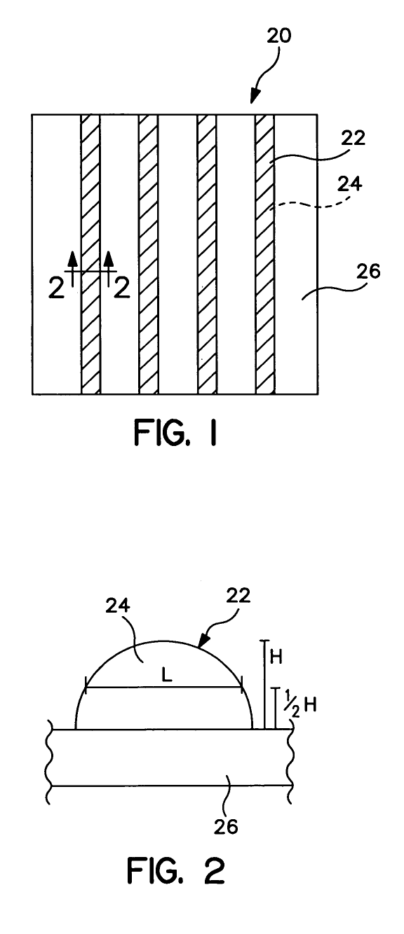

In addition to the functionalities of the particles 24 themselves, the particles lend further functionality to the material 20 by causing a localized change in the thickness of the material. Alternatively, the relatively concentrated stripes 22 of particles 24 add mass, and thus density, along the striped portions of the material. The stripes, therefore, tend to modify fluid movement by directing any fluid to travel along the substrate between the stripes rather than across the stripes. An enlarged cross-sectional view of one stripe 22 is shown in FIG. 2. The maximum height of the stripe is illustrated as “H,” while the half-height, or half of the maximum height, of the stripe is illustrated as “½ H.” The half-height width, or width of the stripe at half-height, is illustrated as “L.” The half-height width of the stripes depends upon the width of a groove in the stripe focusing plate through which the stripe is formed. For example, a stripe focusing plate having a slot width of 9.78 mm may form a stripe having a half-height width between about 7 and 9 mm, as can be seen in the examples below. The definition of the stripe, namely whether the stripe is well-defined or fuzzy, can be measured in a sense by comparing the half-height width, L, to the width of the groove through which the stripe is formed, as explained below.

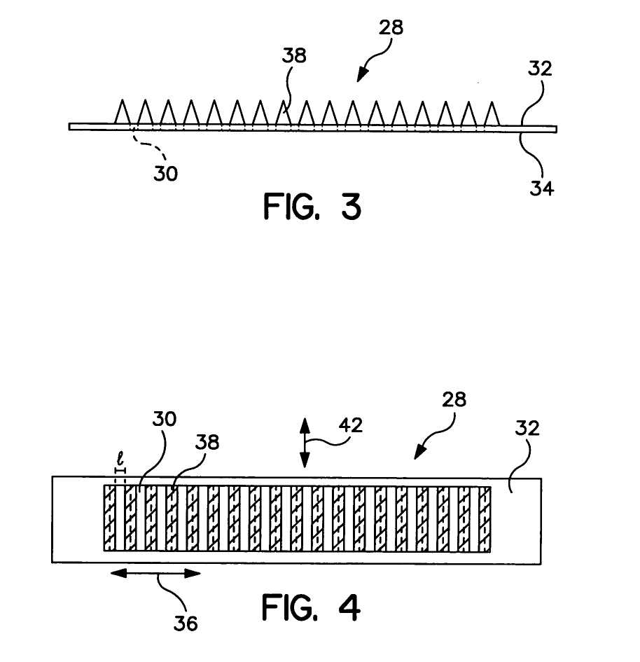

FIGS. 3 and 4 illustrate a stripe focusing plate 28 that can be used to apply the particles 24 to the substrate 26 to form the striped material 20. The stripe focusing plate 28 includes a number of grooves 30 extending through the plate from a top surface 32 of the plate to a bottom surface 34 of the plate. Each groove 30 has a transverse width, l, through which the particles 24 are deposited onto the substrate 26 below the stripe focusing plate 28. Thus, the transverse width of the grooves determines, in large part, the width of the resulting stripes. The transverse width of the grooves may vary considerably depending upon the application for which the striped material is intended, but in some instances may be in a range between about 0.5 and about 1.0 mm. The distance between grooves may also vary depending upon the intended application of the material as well. The transverse direction is indicated in FIG. 4 by arrow 36, which is perpendicular to the direction in which the substrate passes below the stripe focusing plate.

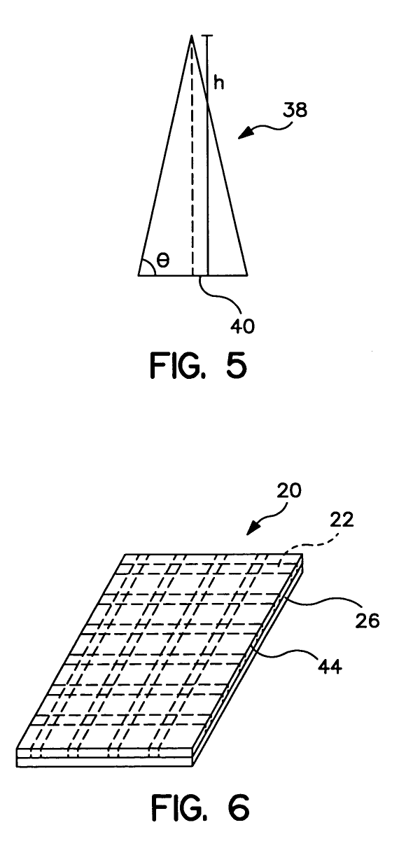

The stripe focusing plate 28 also includes a number of triangular prisms 38 (FIG. 5) each having a base 40 positioned on the top surface 32 of the plate between two grooves 30, with the end prisms positioned adjacent one groove, each prism separated from the next prism by a groove. Each prism 38 suitably has an apex of 45 degrees or less. More particularly, the prisms 38 each have a slope θ between about 45 and about 85 degrees, as shown in the enlarged view of one of the prisms in FIG. 5. The height of the prisms, h, may vary considerably depending upon the distance between the grooves, but in some instances may be in a range between about 0.625 and about 2 inches. Furthermore, the distance between adjacent grooves may also vary considerably, depending upon the desired spacing between stripes, but in some instances may be in a range between about 0.5 and about 5.0 inches. The plate 28 and/or the prisms 38 may include, in whole or in part, a polycarbonate material, or any other suitable material.

To form the stripes 22 on the substrate 26, the particles 24 are distributed onto the stripe focusing plate 28. The particles 24 either fall directly through the grooves 30 onto the substrate 26 below the plate 20 or fall onto the prisms 38 which guide the particles through the grooves onto the substrate to form parallel stripes. As the particles 24 fall onto the substrate 26, the substrate is suitably moved in a machine direction (indicated by arrow 42 in FIG. 4) below the plate to allow stripes to form along the length of the substrate. Alternatively, the stripe focusing plate could be moved along the length of the substrate while the substrate remains in place. As another alternative, the stripes may be applied in both the machine direction and the cross direction, by passing the substrate below the stripe focusing plate 28 in one direction and subsequently in a second, suitably perpendicular direction, thereby forming checks, as shown in FIG. 6.

The particles 24 may be deposited onto the plate 20 by any suitable dispensing apparatus, such as a feeder made by Christy Machine Company. As will be obvious to one skilled in the art, the absolute flux through any one section of the Stripe Focusing Plate is of consequence only in relation to other essential non-woven machine parameters which determine such web characteristics as basis weight and line speed, with each “section” of the plate referring to a part of the plate required to produce one stripe. Therefore, the ratio of the mass of the particles to the mass of the web are reported, rather than add-on level of the particles per se. In one embodiment, for example, the particles may be deposited onto the plate to produce a web that is 0 to about 10% particles per stripe, or between about 1 and about 5% particles per stripe.

The striped material 20 of the invention, in particular the striped material formed using the stripe focusing plate 28 of the invention, is relatively uniform and well-defined. For many purposes the definition of the stripe is important. The definition of a stripe may be described as how sharply the edge of the stripe is manifest. One quantitative way of expressing this edge involves the width of the stripe at half the maximum value of the stripe (i.e., half-height width). The half-height width of stripes made up of pigments, for example, may be determined optically, but for other types of particles that are not as visually detectable, the half-height width may be expressed in terms of weight or other quantitative measure. Therefore, one way to express the effectiveness of the stripe focusing plate is a sharpness coefficient (L/l), which is the half-height width, L, of the resulting stripes 22 divided by the transverse width, l, of the grooves 30 of the stripe focusing plate 28. Suitably, the stripes 22 of the striped material 20 of the invention have a sharpness coefficient L/l of less than 1, which essentially means that the half-height width of the stripes 22 is less than the transverse width of the grooves 30. Furthermore, the sharpness coefficient may be between about 0.1 and about 1.0, or between about 0.6 and about 0.8. A sharpness coefficient of less than 1 indicates that the stripes are uniform and concentrated to such an extent that the particles 24 do not scatter much farther than the width, l, of the grooves 30 through which the particles are deposited, even with high add-on levels. Thus, the stripes 22 may consequently have a rounded cross-section, as illustrated in FIG. 2.

The particles 24 may be deposited onto any suitable substrate 26, such as an airlaid material. As mentioned, an absorbent substrate would be particularly suitable in a number of embodiments. Other suitable substrate materials may include other nonwoven webs formed by such processes as, for example, spunbonding, meltblowing, airformed, wetlaid, coform and bonded carded processes, and combinations of such materials. In one embodiment, shown in FIG. 6, a second substrate 44 may be applied over the stripes 22 on the substrate 26. The second substrate 44 may also be a nonwoven web, such as an airlaid, or any other suitable material.

The striped material 20 of the invention is particularly suitable for use in disposable absorbent products including, without limitation, diapers, training pants, swimwear, absorbent underpants, adult incontinence products, feminine hygiene products, absorbent wipes, and the like, as well as protective garments, including medical garments and industrial protective garments. Medical garments include surgical garments, gowns, aprons, face masks, absorbent drapes, and the like. Industrial protective garments include protective uniforms, workwear, and the like.

### EXAMPLES

### Example 1

A stripe focusing plate, in accordance with the invention, was used to produce stripes of 98% UCARE JR-30M and 2% FD&C Red 40. More particularly, the plate and prisms were both polycarbonate, with the grooves in the plate having a transverse width l of 0.953 cm. The bases of the isosceles triangular prisms were 0.63 cm, with a height of 1.5 cm. Thus, the prisms had a slope of about 78 degrees.

A 57.5 gsm layer of a 90% Foley Fluff/10% T-255 binder fiber was first deposited onto a wire screen using airlaid process equipment. Foley pulp is available from Buckeye in Memphis, Tenn., and T-255 binder fibers are available from KoSA Inc. (formerly Trevira Inc. and formerly Hoechst-Celanese), Salisbury, N.C. Next, a feeder made by Christy Machine Company in Fremont, Ohio, was used to dispense 35 gsm of powder (98% UCARE JR-30M and 2% FD&C Red 40) through the stripe focusing plate onto the airlaid sheet. The particles, deposited at a rate of 6.5 grams/minute, fell onto the sides of the prisms and slid down through the grooves and onto the airlaid sheet forming stripes. The stripe focusing plate was designed to create 1 cm wide stripes with 2 cm between the stripes. The stripes produced were sharply defined and uniform, measuring from 0.7 to 1 cm in width, with an average half-height width of 0.76 cm. A second layer of 57.5 gsm 90% Foley Fluff/10% T-255 binder fiber was then deposited over the stripes to give a final basis weight of 150 gsm.

### Example 2

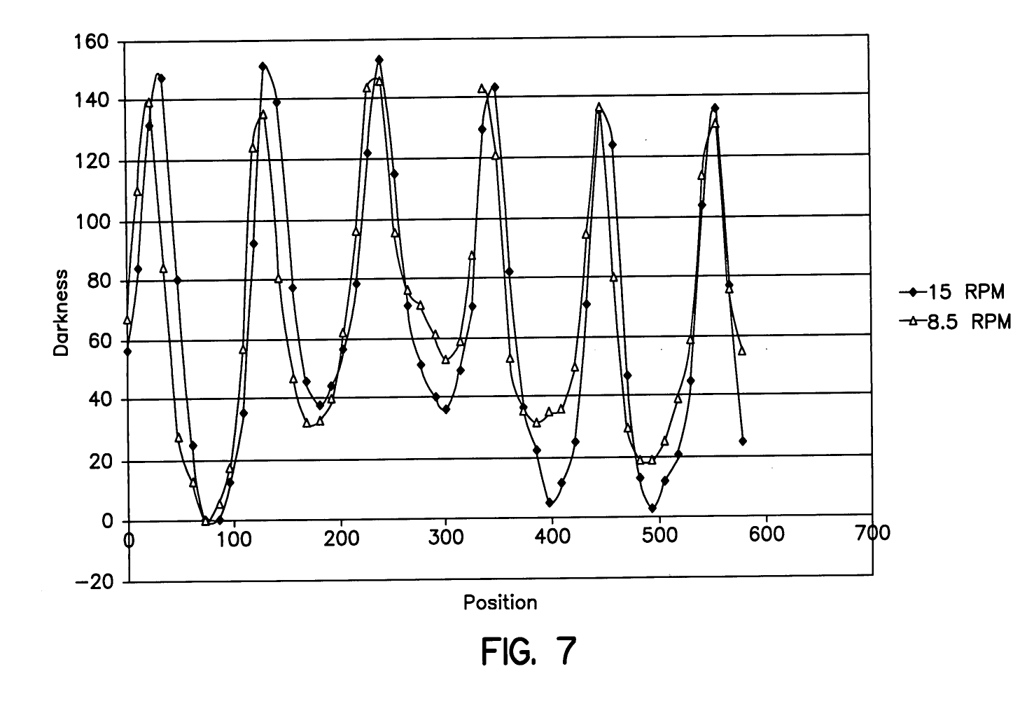

A stripe focusing plate, as described in Example 1, was used to apply stripes of carbon black to two identical airlaid substrates, as described in Example 1, with each of the two samples having the particles deposited onto the substrate through the stripe focusing plate at different rates. The rates were 8.5 and 15 RPM on the Christy Feeder. Stripes were formed on each of the two samples, the only difference between the samples being the rate at which the particles were deposited. Optical profilimetry was used to measure brightness and darkness along the width (across all stripes) of each sample. The darkness along each position of the width for each sample was plotted on the graph shown in FIG. 7. This data was used to calculate the half-height width of each of the stripes of each sample, shown in Table 1.

TABLE 1
Half-Height Width of Stripes

| Rate | | |
|---|---|---|
| (RPM) | Stripe | Line Width at ½ Max (mm) |
| 8.5 | 1 | 7.63 |
| | 2 | 8.14 |
| | 3 | 9.43 |
| | 4 | 8.39 |
| | Average | 8.40 |
| | Standard Deviation | 0.75 |
| 15 | 1 | 8.39 |
| | 2 | 8.86 |
| | 3 | 8.74 |
| | 4 | 8.74 |
| | 5 | 7.06 |
| | 6 | 7.85 |
| | Average | 8.27 |
| | Standard Deviation | 0.70 |

The sharpness coefficients, L/l, of each of the samples are shown in Table 2.

TABLE 2
Sharpness Coefficients of Stripes

| Sample | RPM | Sharpness Coefficient |
|---|---|---|
| 1 | 8.5 | 0.88 |
| 2 | 15 | 0.87 |

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A striped material, comprising:
a substrate; and
a plurality of stripes formed by a plurality of particles deposited onto the substrate through a slot having a width l, each of the stripes having a half-height width L, wherein each stripe has a sharpness coefficient L/l of less than 1.

2. The striped material of claim 1, wherein the particles comprise a gelling agent.

3. The striped material of claim 1, wherein the particles comprise a superabsorbent.

4. The striped material of claim 1, wherein the particles comprise activated carbon.

5. The striped material of claim 1, wherein the particles comprise a pigment.

6. The striped material of claim 1, wherein the stripes are parallel to one another.

7. The striped material of claim 6, further comprising a second plurality of stripes perpendicular to the plurality of stripes.

8. The striped material of claim 1, wherein the substrate comprises a nonwoven material selected from the group consisting of airlaid, spunbond, meltblown, airformed, wetlaid, coform, bonded carded webs, and combinations thereof.

9. The striped material of claim 1, further comprising a second substrate such that the plurality of stripes is positioned between the two substrates.

10. The striped material of claim 9, wherein the second substrate comprises a nonwoven material selected from the group consisting of airlaid, spunbond, meltblown, airformed, wetlaid, coform, bonded carded webs, and combinations thereof.

11. The striped material of claim 1, wherein a ratio of a mass of the particles to a mass of the substrate is between about 0% and about 10% particles per stripe.

12. The striped material of claim 1, wherein a ratio of a mass of the particles to a mass of the substrate is between about 1% and about 5% particles per stripe.

13. A disposable absorbent article, comprising:
a substrate; and
a plurality of stripes formed by a plurality of particles deposited onto the substrate through a slot having a width l, each of the stripes having a half-height width L, wherein each stripe has a sharpness coefficient L/l of less than 1.

14. The disposable absorbent article of claim 13, wherein the particles comprise at least one of the group consisting of a gelling agent, a superabsorbent, activated carbon, and a pigment.

15. The disposable absorbent article of claim 13, wherein the stripes are parallel to one another.

16. The disposable absorbent article of claim 15, further comprising a second plurality of stripes perpendicular to the plurality of stripes.

17. The disposable absorbent article of claim 13, wherein the substrate comprises a nonwoven material selected from the group consisting of airlaid, spunbond, meltblown, airformed, wetlaid, coform, bonded carded webs, and combinations thereof.

18. The disposable absorbent article of claim 13, further comprising a second substrate such that the plurality of stripes is positioned between the two substrates.

19. The disposable absorbent article of claim 18, wherein the second substrate comprises a nonwoven material selected from the group consisting of airlaid, spunbond, meltblown, airformed, wetlaid, coform, bonded carded webs, and combinations thereof.

20. The disposable absorbent article of claim 13, wherein a ratio of a mass of the particles to a mass of the substrate is between about 0% and about 10% particles per stripe.

21. The disposable absorbent article of claim 13, wherein a ratio of a mass of the particles to a mass of the substrate is between about 1% and about 5% particles per stripe.

22. A catamenial article comprising the disposable absorbent article of claim 13.

23. A stripe focusing plate, comprising:
a plate having a plurality of grooves extending through the plate between a first surface and a second surface of the plate, each groove having a transverse width l; and
a plurality of triangular prisms, separate from one another and positioned on top of the first surface of the plate, with a base of each of the prisms positioned adjacent at least one of the grooves, the prisms each having a slope between about 45 and about 85 degrees, wherein a plurality of particles distributed onto the first surface falls through the grooves onto a substrate positioned below the second surface, thereby forming a plurality of stripes on the substrate, each stripe having a half-height width L, wherein each stripe has a sharpness coefficient L/l of less than 1.

24. The stripe focusing plate of claim 23, wherein the plate comprises a polycarbonate material.

25. The stripe focusing plate of claim 23, wherein the plurality of prisms comprise a polycarbonate material.

26. The stripe focusing plate of claim 23, wherein each of the plurality of prisms has a height between about 0.625 and about 2 inches.

27. The stripe focusing plate of claim 23, wherein the transverse width l is between about 0.5 and about 1 inch.
